(19) United States
(12) Patent Application Publication
(10) Pub. No.: US 2024/0346869 A1
(43) Pub. Date: Oct. 17, 2024

(54) INFRARED SECURITY SYSTEM

(71) Applicant: NITTO DENKO CORPORATION, Osaka (JP)

(72) Inventors: Mami KAWAGUCHI, Osaka (JP); Yudai NUMATA, Osaka (JP); Shoichi MATSUDA, Osaka (JP); Ryu YAMAMOTO, Tokyo (JP)

(73) Assignee: NITTO DENKO CORPORATION, Osaka (JP)

(21) Appl. No.: 18/293,069

(22) PCT Filed: Mar. 29, 2022
(86) PCT No.: PCT/JP2022/015593

§ 371 Date: Jan. 29, 2024

Related U.S. Application Data
(60) Provisional application No. 63/227,413, filed on Jul. 30, 2021.

(51) Int. Cl. G07C 9/29; G06K 7/12

(52) U.S. Cl. CPC G07C 9/29; G06K 7/12

(57) ABSTRACT

The present invention strengthens the security level of an infrared security system. The infrared security system for managing unlocking of a lock includes: at least one detection unit that includes an optical laminate and an infrared detection device which is disposed so as to receive infrared light via the optical laminate; and a security system that operates on the basis of output from the infrared detection device. The security system is configured to generate time-series data that indicates motion of a subject on the basis of a subject signal generated when the infrared detection device receives, via the optical laminate, infrared light which has been emitted from a light-emitting device toward the subject and which has been reflected by the subject, and to unlock the lock on the basis of the time-series data.

### TECHNICAL FIELD

The present invention relates to an infrared security system, and specifically, to an infrared security system that may be installed so as not to be visually recognizable from outside.

### BACKGROUND ART

Security systems using infrared rays (hereinafter, referred to as “infrared security systems”) have been developed and put into practice. For example, authentication technologies using infrared rays, such as iris authentication, face authentication, vein authentication and the like, have been put into practice. The definition of the “infrared rays” varies in accordance with the technological art. In this specification, the term “infrared rays” refers to light that includes at least light (electromagnetic waves) having a wavelength in the range not shorter than 760 nm and not longer than 2000 nm and that is used for sensing. The “visible light” refers to light having a wavelength in the range not shorter than 400 nm and shorter than 760 nm.

Patent Document 1 discloses a door security system using two-dimensional information. The door security system uses infrared rays. The two-dimensional information is printed on an object, and is not visible under visible light but is visible only when being irradiated with infrared rays.

Patent Document 2 discloses a human mobility analysis system including an image capturing terminal and an analysis server connectable with each other via a network. The image capturing terminal is located in, for example, a store or a train station. The analysis server analyzes the human mobility based on the captured image acquired by the image capturing terminal.

### CITATION LIST

### Patent Literature

Patent Document 1: Japanese Laid-Open Patent Publication No. 2011-149204
Patent Document 2: Japanese Laid-Open Patent Publication No. 2017-224148

### SUMMARY OF INVENTION

### Technical Problem

The conventional monitoring camera as disclosed in each of Patent Documents 1 and 2 is installed so as to be visually recognizable by humans. Therefore, there may be cases where a third party recognizes the location of an unlocking system therefor and this causes a risk of the lock being released, or where people get to know the presence of the monitoring camera and make an act or motion that they would not make without such knowledge and this causes a security problem. As a result, a system providing a high level of security may not be realized.

From the point of view of improving the security, it is conceivable to hide the monitoring camera or a light source that emits infrared rays in, for example, a structural body in a building, such that the monitoring camera or the light source is not visually recognizable from outside. In this case, an infrared-transmissive filter may be used to prevent the monitoring camera or the light source from being noticed.

However, conventional mainstream infrared-transmissive filters exhibit a black color in order to absorb visible light. Therefore, it may be occasionally difficult to harmonize the color of a periphery of an area where the monitoring camera is located and the color of the surface of the infrared-transmissive filter such that these colors are indistinguishable from each other. This causes a problem of poor design. In this case, the position of the monitoring camera may be easily specified even if being hidden by the infrared-transmissive filter. Still, the security problem is not solved.

The present invention made to solve at least one of the above-described problems has an object of providing an infrared security system capable of improving the level of security or an infrared security system or a design unit capable of exhibiting a high level of design.

### Solution to Problem

Embodiments of the present invention provide the solution to the problem described in the following items.

### [Item 1]

An infrared security system managing release of lock, including:
at least one detection unit including an optical stack and an infrared detection device located so as to receive infrared rays through the optical stack; and
a security system operative based on an output from the infrared detection device,
wherein the security system is configured to:
   generate time series data representing a motion of a subject based on a subject signal generated by the infrared detection device when the infrared detection device receives, through the optical stack, infrared rays emitted from a light emitting device toward the subject and reflected by the subject, and
   release the lock based on the time series data.

### [Item 2]

The infrared security system of item 1, wherein the security system:
calculates a positional relationship of the subject to the infrared detection device based on the subject signal from the infrared detection device, and
releases the lock based on the time series data and the positional relationship.

### [Item 3]

The infrared security system of item 1, further including an input device converting an unlocking code, input by the subject, into data and inputting the data to the security system,
wherein the security system releases the lock in the case where the motion of the subject matches a designated motion pattern and the input unlocking code matches a designated code.

### [Item 4]

An infrared security system managing release of lock, including:
at least one detection unit including an optical stack and an infrared detection device located so as to receive infrared rays through the optical stack;
a security system operative based on an output from the infrared detection device; and
an input device converting an unlocking code, input by a subject, into data and inputting the data to the security system,
wherein the security system is configured to:
   calculate a positional relationship of the subject to the infrared detection device based on a subject signal generated by the infrared detection device when the infrared detection device receives, through the optical stack, infrared rays emitted from a light emitting device toward the subject and reflected by the subject, and
   release the lock based on the calculated positional relationship and the input unlocking code.

### [Item 5]

The infrared security system of any one of items 1 through 4,
wherein where a design of a surface of a periphery of an area where the at least one detection unit is located is referred to as a periphery design and a design of a surface of the optical stack is referred to as a detector design, the detector design is similar to the periphery design, and
wherein the security system operates referring to a blank signal not including information on a subject, the blank signal being generated by the infrared detection device when the infrared detection device receives reference infrared rays through the optical stack.

### [Item 6]

The infrared security system of item 5, wherein the security system acquires the blank signal every certain period of time.

### [Item 7]

The infrared security system of item 5 or 6,
wherein the periphery design and the detector design each include a pattern, and
wherein the infrared security system further includes a storage device storing the blank signal specific to the pattern.

### [Item 8]

The infrared security system of any one of items 5 through 7, wherein the security system generates time series data based on a difference between the subject signal and the blank signal.

### [Item 9]

The infrared security system of any one of items 1 through 4,
wherein a value of L* at a surface of the optical stack measured by an SCE method is not smaller than 4, and
wherein the infrared detection device is located on a side opposite to the surface of the optical stack such that a position of the infrared detection device is not specified.

[Item 10]

The infrared security system of item 9, wherein where a color of a surface of a periphery of an area where the at least one detection unit is located is referred to as a periphery color and a color of a surface of the at least one detection unit is referred to as a detector color, neither the periphery color nor the detector color is black, and a color difference between the periphery color and the detector color measured by the SCE method is not larger than 3.

[Item 11]

The infrared security system of any one of items 1 through 10, wherein the at least one detection unit includes the light emitting device emitting infrared rays outside through the optical stack.

[Item 12]

The infrared security system of any one of items 1 through 11, wherein the at least one detection unit includes a plurality of detection units.

### [Item 13]

An infrared security system managing release of lock, including:
at least one detection unit including an optical stack and an infrared detection device located so as to receive infrared rays through the optical stack; and
a security system configured to release the lock based on an output from the infrared detection device,
wherein where a design of a surface of a periphery of an area where the at least one detection unit is located is referred to as a periphery design and a design of a surface of the optical stack is referred to as a detector design, the detector design and the periphery design are the same as, or similar to, each other, and
wherein the security system operates referring to a blank signal not including information on a subject, the blank signal being generated by the infrared detection device when the infrared detection device receives reference infrared rays through the optical stack.

### [Item 14]

The infrared security system of item 13,
wherein the entirety of the detection design and the periphery design includes a single pattern, and
wherein the optical stack included in each of the one or the plurality of detection units is located at an arbitrary position in the single pattern, and the one or the plurality of detection units are each hidden on a rear side of the optical stack.

[Item 15]

The infrared security system of item 13,
wherein the detector design and the periphery design include a plurality of zones separated from each other by a visually recognizable border,
wherein the optical stack included in each of the one or the plurality of detection units is located in a different zone among the plurality of zones, and the one or the plurality of detection units are each hidden on a rear side of the optical stack, and
wherein the plurality of zones each have an arbitrary color or pattern.

### [Item 16]

The infrared security system of any one of items 1 through 15, wherein the optical stack includes a visible light scattering layer containing fine particles acting as light scattering elements dispersed in a matrix, the visible light scattering layer having a regular transmittance not lower than 60% for light having a wavelength in at least a part of the wavelength range not shorter than 760 nm and not longer than 2000 nm.

### [Item 17]

The infrared security system of item 16, wherein the fine particles form at least a colloidal amorphous array.

### [Item 18]

The infrared security system of item 16 or 17, wherein a transmittance curve of the visible light scattering layer for light in a wavelength range of visible light includes a curved portion in which the regular transmittance monotonously decreases from a longer wavelength side to a shorter wavelength side, and the curved portion is shifted to the longer wavelength side as an angle of incidence is increased.

### Advantageous Effects of Invention

Embodiments of the present invention provide an infrared security system capable of improving the level of security.

### BRIEF DESCRIPTION OF DRAWINGS

FIG. 1 schematically shows an example of structure of an infrared security system.

FIG. 2 is a block diagram showing an example of hardware configuration of a detection unit.

FIG. 3 is a block diagram schematically showing an example of hardware configuration of a security system.

FIG. 4 shows an example of structure of the detection unit installed inside a wall of a building.

FIG. 5 is a schematic cross-sectional view of an optical stack.

FIG. 6 is a schematic cross-sectional view of a visible light scattering layer.

FIG. 7 shows a cross-sectional TEM image of the visible light scattering layer.

FIG. 8 is a graph showing the angle-of-incidence dependence of the regular transmittance spectrum of the visible light scattering layer normalized by the maximum transmittance.

FIG. 9A is a schematic view showing an example of design of a continuous pattern.

FIG. 9B is a schematic view showing another example of design of a continuous pattern.

FIG. 9C is a schematic view showing an example of tile-like design.

FIG. 9D is a schematic view showing another example of tile-like design.

FIG. 10 shows an example in which locking of a conference room is managed by a hand gesture.

FIG. 11 is a schematic view showing a plurality of detection units installed inside a wall.

FIG. 12 shows an example in which detection units are installed inside the wall and one or more light source units are located in a ceiling so as not to be seen from outside.

FIG. 13 is a block diagram showing, with functional blocks, an example of process executed by a processor in the case where the security system tracks a motion of a moving body.

FIG. 14 is a flowchart showing an example of procedure of tracking the motion of the moving body.

FIG. 15 is a block diagram showing, with functional blocks, an example of process executed by the processor in a security system in example 1.

FIG. 16 is a schematic view showing a detection unit installed inside the wall and an input device installed on the wall.

FIG. 17 is a block diagram showing, with functional blocks, an example of process executed by the processor in a security system in example 2.

FIG. 18 is a block diagram showing, with functional blocks, an example of process executed by the processor in a security system in example 3.

### DESCRIPTION OF EMBODIMENTS

Hereinafter, an infrared security system according to an embodiment of the present invention will be described with reference to the drawings. An infrared security system according to an embodiment of the present invention is not limited to any of those described below as examples.

An infrared security system according to an embodiment of the present invention includes at least one detection unit including an optical stack and an infrared detection device located so as to receive infrared rays through the optical stack, and a security system operative based on an output from the infrared detection device. The at least one detection unit may include a light emitting device that emits infrared rays outside through the optical stack.

The optical stack includes a visible light scattering layer including fine particles acting as light scattering elements dispersed in a matrix, the visible light scattering layer having a regular transmittance not lower than 60% for light having a wavelength in at least a part of the wavelength range not shorter than 760 nm and not longer than 2000 nm. For example, a visible light scattering layer having a regular transmittance not lower than 60% for light having a wavelength of 950 nm and for light having a wavelength of 1550 nm is provided. The wavelength range of the light (near infrared rays) for which the visible light scattering layer has a regular transmittance not lower than 60% is preferably, for example, not shorter than 810 nm and not longer than 1700 nm, and more preferably, not shorter than 840 nm and not longer than 1650 nm. Herein, it is preferred that the matrix and the fine particles are both transparent to the visible light (hereinafter, referred to simply as “transparent”).

In addition, the visible light scattering layer may have a feature in optical characteristics that a transmittance curve thereof for light in the wavelength range of visible light includes a curved portion in which the regular transmittance monotonously decreases from a longer wavelength side to a shorter wavelength side, and that the curved portion is shifted to the longer wavelength side as the angle of incidence is increased.

In the infrared security system according to an embodiment of the present invention, a value of L* at a surface of the optical stack measured by an SCE method by use of a spectrophotometer is not smaller than 4, and the infrared detection device is located on a side opposite to the surface of the optical stack such that a position of the infrared detection device is not specified. The visible light scattering layer according to an embodiment of the present invention may exhibit gray in the case where, for example, the value of L* is not smaller than 4, and may exhibit white in the case where the value of L* is not smaller than 20.

In an infrared security system according to one embodiment of the present invention, where a color of a surface of a periphery of an area where the at least one detection unit is located is referred to as a periphery color and a color of a surface of the at least one detection unit is referred to as a detector color, neither the periphery color nor the detector color is black, and a color difference between the periphery color and the detector color measured by the SCE method is not larger than 3. Herein, the “color difference not larger than 3” refers to the following: where the a* value and the b* value of the surface of the periphery in an L*a*b* color coordinate system are respectively a₁* and b₁*, and the a* value and the b* value of the surface of the detection unit in the L*a*b* color coordinate system are respectively a₂* and b_{2*}, the conditions of numerical formulas in expression 1 are satisfied.

$$\vert {a}_{1}^{★} - {a}_{2}^{★} \vert \leq 3 and \vert {b}_{1}^{★} - {b}_{2}^{★} \vert \leq 3 \qquad [ Expression 1 ]$$

An infrared security system according to another embodiment of the present invention is an infrared security system that manages release of lock. The security system may be configured to generate time series data representing a motion of a subject based on a subject signal generated by the infrared detection device when the infrared detection device receives, through the optical stack, infrared rays that are emitted from the light emitting device toward the subject and are reflected by the subject, and to release the lock based on the time series data. Alternatively, the security system may be configured to calculate a positional relationship of the subject to the infrared detection device and to release the lock based on the calculated positional relationship. In an embodiment of the present invention, the subject is a human being. It should be noted that the subject is not limited to a human being, and may encompass a robot, an animal and the like.

A design unit according to one embodiment of the present invention includes one or a plurality of detection units each including an optical stack and an infrared detection device located so as to receive infrared rays through the optical stack, and an accommodation portion accommodating the one or the plurality of detection units. The accommodation portion has a structural body such as, for example, a wall, a pillar, a floor, a ceiling or the like of a building, that is capable of accommodating the detection unit such that the detection unit is not visually recognizable from outside. An outer surface of the accommodation portion and the surface of the optical stack included in each of the one or the plurality of detection units are in the same flat or curved plane, and the value of L* at the surface of the optical stack measured by the SCE method by use of a spectrophotometer is not smaller than 4. The infrared detection device is located on a side opposite to the surface of the optical stack such that a position of the infrared detection device is not specified. A combination of the design unit and the security system provides an infrared security system that may exhibit a superb design.

An example of structure of an infrared security system according to an illustrative embodiment of the present invention will be described with reference to FIG. 1.

FIG. 1 schematically shows an example of structure of an infrared security system 300 according to an illustrative embodiment of the present invention. The infrared security system 300 may include at least one detection unit 100 and a security system 200 operative based on an output from each of the at least one detection unit 100. Each detection unit 100 is connected with the security system 200 via a wireless network 70 in a wired or wireless manner. The infrared security system 300 may further include at least one edge computer from the point of view of decreasing the communication delay or dispersing the network load.

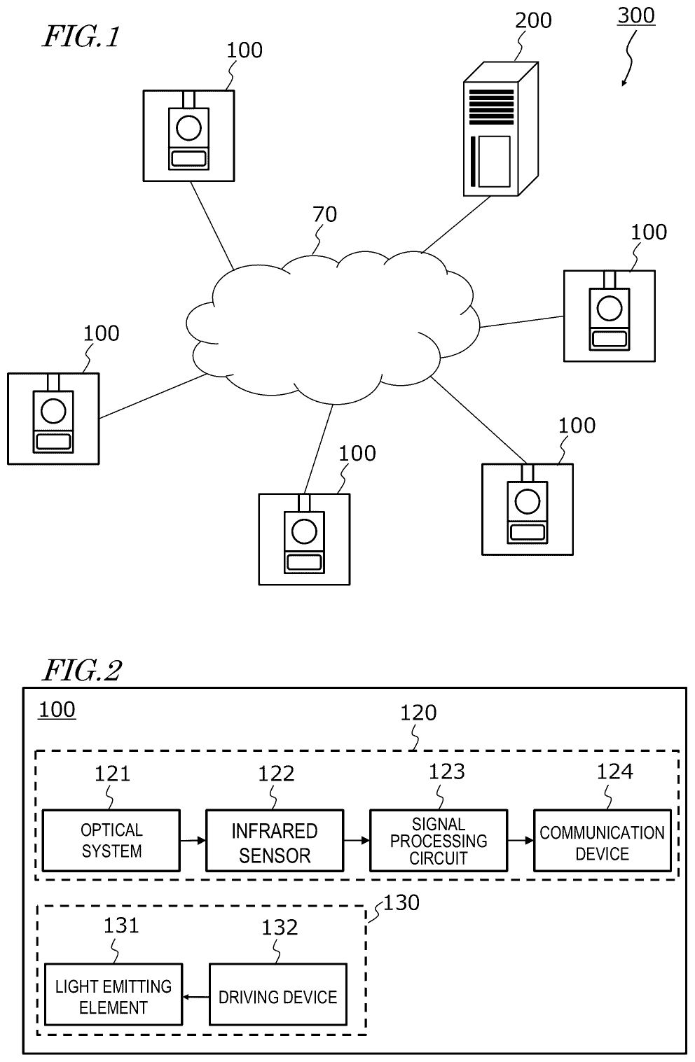

FIG. 2 is a block diagram of an example of hardware configuration of the detection unit 100. The detection unit 100 includes an infrared detection device 120 located so as to receive infrared rays through an optical stack. The detection unit 100 shown in FIG. 2 includes a light emitting device 130 emitting infrared rays outside through the optical stack. It should be noted that as described below, the light emitting device 130 may be provided outside the detection unit 100.

The infrared detection device 120 includes an optical system 121, an infrared sensor 122, a signal processing circuit 123, and a communication device 124. The infrared detection device 120 may be, for example, an infrared camera compliant to an analog Hi-Vision standards such as the AHD system, the HD-CV1 system, the HD-TV1 system or the like.

The optical system 121 may include at least one lens formed of, for example, zinc sulfide or chalcogenide glass. Examples of the infrared sensor 122 include quantum-based sensors such as an nGaAs sensor, an InGaAs/GaAsSb sensor, an InSb sensor and the like.

An example of the signal processing circuit 123 is a DSP (Digital Signal Processor). The signal processing circuit 123 may apply a compression process compliant to, for example, the H.264 or H.265 standards to output data (video data) output from, for example, the infrared sensor 122, and thus may generate compressed data.

The communication device 124 is a communication module communicable with the security system 200 via the network 70. For example, the communication device 124 is capable of performing wired communication compliant to the communication standards such as CameraLink, IEEE1394 (registered trademark), Ethernet (registered trademark) or the like. The communication device 124 is capable of performing wireless communication compliant to, for example, the Wi-Fi standards using the frequency in the 2.4 GHz or 5.0 GHz band.

The light emitting device 130 includes at least one light emitting element 131 emitting infrared rays and a driving device 132. Examples of the light emitting element 131 include a light emitting diode and a semiconductor laser element. The driving device 132, for example, supplies the light emitting element 131 with a driving signal in accordance with a control signal that is output from the security system 200.

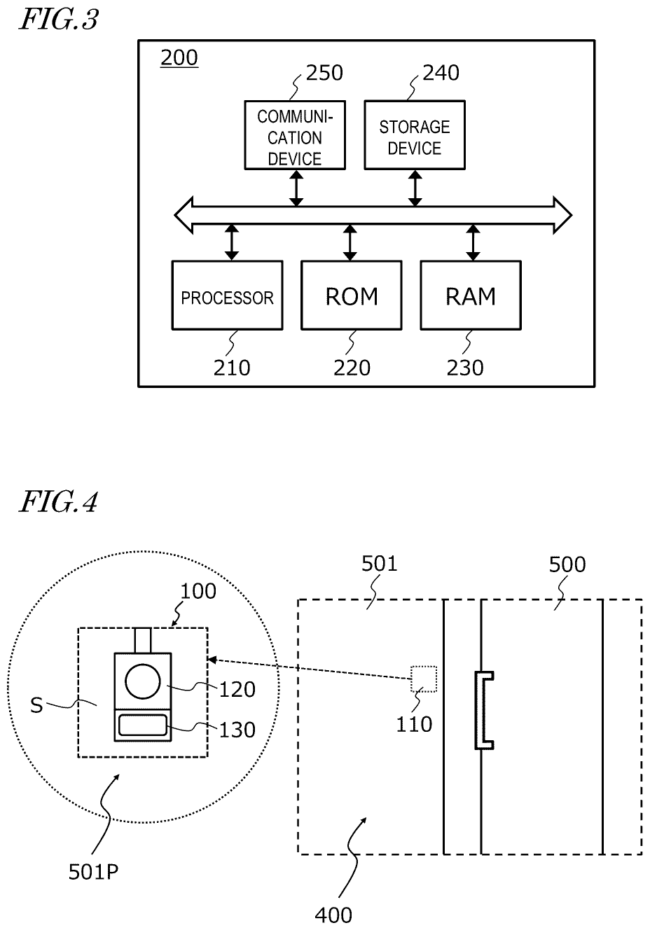

FIG. 3 is a block diagram schematically showing an example of hardware configuration of the security system 200.

The security system 200 according to an embodiment of the present invention is a server computer. It should be noted that the security system 200 may be, for example, a stationary computer, a laptop computer, an edge computing server or an edge IoT server. The security system 200 may be installed at a location far from the detection unit 100, for example, in a management center in a building where the detection unit 100 is installed or in a building of a security company performing comprehensive security management.

The security system 200 includes, for example, a processor 210, a ROM (Read Only Memory) 220, a RAM (Random Access Memory) 230, a storage device 240 and a communication device 250. These components are communicably connected with each other via a bus. Software (or firmware) allowing the processor 210 to execute at least one process may be mounted on the ROM 220. Such software may be recorded on a computer-readable recording medium such as, for example, an optical disc or the like, and marketed as a software package or provided to a user via the network 70.

The processor 210 is a semiconductor integrated circuit, and includes a central processing unit (CPU). The processor 210 may be realized by a microprocessor or a microcontroller. The processor 210 sequentially executes computer programs stored on the ROM 220, the computer programs each including a description of a set of instructions by which at least one process is to be executed, and realizes a desired process.

In addition to, or instead of, the processor 210, the security system 200 may include an FPGA (Field Programmable Gate Array), a GPU (Graphics Processing Unit), an ASIC (Application Specific Integrated Circuit) or an ASSP (Application Specific Standard Product) each having a CPU mounted thereon, or a combination of at least two circuits selected from these circuits.

The ROM 220 is, for example, a writable memory (e.g., PROM), a rewritable memory (e.g., flash memory) or a read-only memory. The ROM 220 stores a program controlling an operation of the processor 210. The ROM 220 does not need to be a single recording medium, and may be an assembly of a plurality of recording mediums. A part of the assembly of the plurality of recording mediums may be a detachable memory.

The RAM 230 provides a work area in which the control program stored on the ROM 220 is to be developed once at the time of booting. The RAM 230 does not need to be a single recording medium, and may be an assembly of a plurality of recording mediums.

The storage device 240 mainly acts as a storage of a database. The storage device 240 is, for example, a magnetic storage device or a semiconductor storage device. An example of the magnetic storage device is a hard disc drive (HDD). An example of the semiconductor storage device is a solid state drive (SSD). It should be noted that the storage device 240 may be an external storage device connectable with a server via the network 70. The storage device 240 may store, for example, video streaming data that is output from the detection unit 100.

The communication device 250 is a communication module communicable with the detection unit 100 via the network 70. Like the communication device 124, the communication device 250 is capable of performing wired communication compliant to the communication standards such as, for example, CameraLink, IEEE1394 (registered trademark), Ethernet (registered trademark) or the like. The communication device 250 is capable of performing wireless communication compliant to, for example, the Wi-Fi standards using the frequency in the 2.4 GHz or 5.0 GHz band.

FIG. 4 shows an example of structure of the detection unit 100 installed inside a wall 501 of a building. FIG. 4 shows an entrance to an indoor conference room having a door 500 as an example.

The detection unit 100 is installed in the wall 501 in contact with the door 500, more specifically, in a space S close to a door knob, so as not to be visually recognizable from outside; in other words, such that the position of the detection unit 100 is not specified. An optical stack 110 is located at a position crossing the infrared rays emitted from the light emitting device 130, so as to close an opening of the space S of the wall 501. With such a positional arrangement, the optical stack 110 is capable of hiding the infrared detection device 120 and the light emitting device 130. Each of vertical and horizontal sizes of the optical stack 110 is, for example, not shorter than 10 cm and not longer than 15 cm. The detection unit 100 may be located at a height of, for example, not shorter than 100 cm and not longer than 170 cm from the floor. Instead of merely closing the opening of the space S, the optical stack 110 may be located on the entirety of the wall 501 including the opening.

Now, with reference to FIG. 5 through FIG. 8, the structure and optical characteristics of the optical stack 110 will be described.

FIG. 5 is a schematic cross-sectional view of the optical stack 110. The optical stack 110 according to an embodiment of the present invention includes a visible light scattering layer 110A, a substrate layer 110B supporting the visible light scattering layer 110A, and a design layer 110C located on the visible light scattering layer 110A.

The substrate layer 110B has a mechanical strength appropriate as a cover of the detection unit 100, and has a high infrared transmittance. The substrate layer 110B may be formed of, for example, a transparent plastic material such as an acrylic resin or the like. The substrate layer 110B may exhibit a black color in order to have improved visual recognition suppressibility under the visible light, and may include a mirror-like dielectric multi-layer film. The substrate layer 110B has a thickness that is, for example, not less about 2 μm and not greater than about 10 mm.

The visible light scattering layer 110A according to an embodiment of the present invention exhibits an achromatic color that is not black. Any color having a value of L* not smaller than 4 measured by an SCE method on a CIE 1976 color space is considered as an achromatic color that is not black. The visible light scattering layer 110A may exhibit, for example, a white color. Herein, the “white color” refers to a color having x and y coordinates in ranges of 0.25≤x≤0.40 and 0.25≤y≤0.40 on a CIE 1931 chromaticity diagram, with the standard light being from a D65 light source. Needless to say, a color closer to x=0.333 and y=0.333 has a higher degree of whiteness. The x and y coordinates are preferably 0.28≤x≤0.37 and 0.28≤y≤0.37, and more preferably 0.30≤x≤0.35 and 0.30≤y≤0.35. The value of L* measured by the SCE method on the CIE 1976 color space is preferably not smaller than 20, more preferably, not smaller than 40, still more preferably, not smaller than 50, and especially preferably, not smaller than 60. A color having a value of L* not smaller than 20 may generally be considered as a white color. The upper limit of the value of L* is, for example, 100. The measurement by the SCE method may be performed by use of, for example, a spectrophotometer CM-2600-D (produced by Konica Minolta Japan, Inc.).

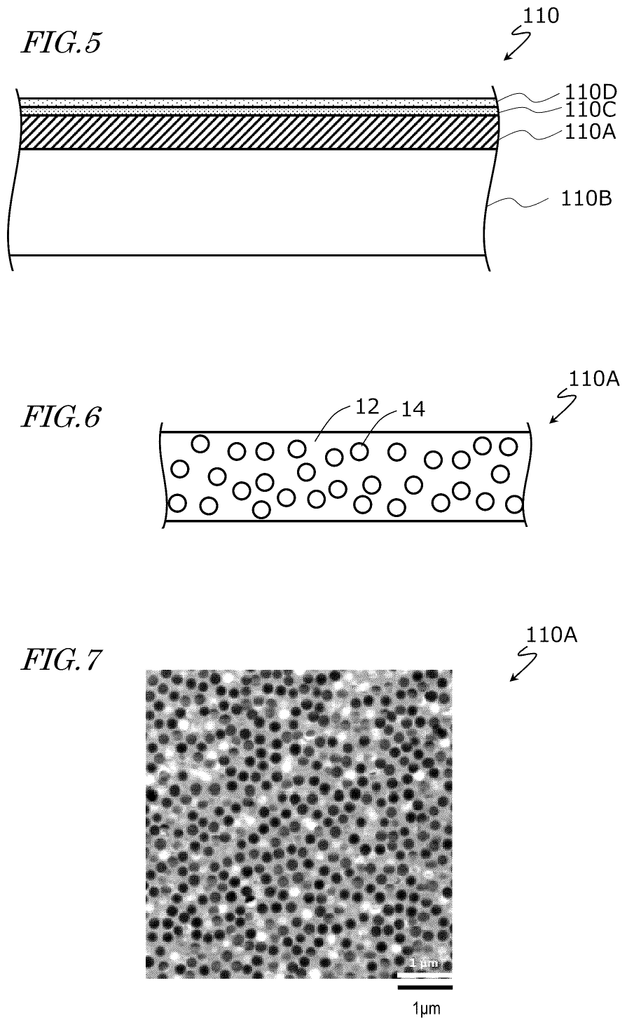

FIG. 6 is a schematic cross-sectional view of the visible light scattering layer 110A. The optical stack 110 includes the visible light scattering layer 110A containing fine particles 14 acting as light scattering elements dispersed in a matrix 12. The visible light scattering layer 110A according to an embodiment of the present invention contains the matrix 12, which is transparent to visible light, and the fine particles 14, which are transparent and dispersed in the transparent matrix 12. The fine particles 14 behave as the light scattering elements. The fine particles 14 may form, for example, at least a colloidal amorphous array. In this case, the visible light scattering layer 110A may include other fine particles that do not disturb the colloidal amorphous array formed of the fine particles 14.

As schematically shown in FIG. 6, the visible light scattering layer 110A has a substantially flat surface. Herein, the expression “substantially flat surface” refers to a surface that does not have a concaved and convexed structure of such a size as to scatter (diffract) or diffuse-reflect visible light or infrared rays. The visible light scattering layer 110A does not contain a cholesteric liquid crystal material (encompassing a polymeric liquid crystal material, a low-molecular weight liquid crystal material, a mixture thereof, and such a liquid crystal material mixed with a crosslinker to be, for example, crosslinked and thus solidified; encompassing a wide range of liquid crystal material having a cholesteric phase). The visible light scattering layer 110A is, for example, film-like, but is not limited to this.

The transparent fine particles 14 are, for example, silica fine particles. Usable as the silica fine particles are silica fine particles synthesized by, for example, a Stober method. As the fine particles, inorganic fine particles other than silica fine particles may be used. Resinous fine particles may be used. The resinous fine particles are preferably fine particles formed of at least one of, for example, polystyrene and poly(methyl methacrylate), and more preferably fine particles formed of crosslinked polystyrene, crosslinked poly(methyl methacrylate) or crosslinked styrene-methyl methacrylate copolymer. As such fine particles, for example, polystyrene fine particles or poly(methyl methacrylate) fine particles synthesized by emulsion polymerization may be used when appropriate. Alternatively, air-containing hollow silica fine particles or hollow resinous fine particles may be used. Fine particles formed of an inorganic material are advantageous in being highly resistant against heat and light. The fine particles have a volume fraction that is preferably not lower than 6% and not higher than 60%, more preferably, not lower than 20% and not higher than 50%, and still more preferably, not lower than 20% and not higher than 40% with respect to the entirety of the visible light scattering layer (containing the matrix and the fine particles). The transparent fine particles 14 may have optical isotropy.

The matrix 12 may be formed of, for example, acrylic resin (e.g., poly(methyl methacrylate), poly(methyl acrylate)), polycarbonate, polyester, poly(diethyleneglycolbisallylcarbonate), polyurethane, epoxy resin, or polyimide, but is not limited to being formed of any of these materials. It is preferred that the matrix 12 is formed of a curable (thermosetting or photocurable) resin. From the point of view of mass-productivity, it is preferred that the matrix 12 is formed of a photocurable resin. As the photocurable resin, any of various (meth)acrylates is usable. It is preferred that such a (meth)acrylate contains two-functional or at least three-functional (meth)acrylate. It is preferred that the matrix 12 has optical isotropy. Use of a curable resin containing a polyfunctional monomer allows the matrix 12 to have a crosslinked structure. Therefore, the heat resistance and the light resistance are improved.

The visible light scattering layer 110A containing the matrix 12 formed of a resin material may be like a flexible film. The visible light scattering layer 110A has a thickness that is, for example, not less than 10 μm and not greater than 10 mm. As long as the thickness of the visible light scattering layer 110A is, for example, not less than 10 μm and not greater than 1 mm, or further, not less than 10 μm and not greater than 500 μm, the flexibility thereof is conspicuously expressed.

In the case where silica fine particles having a hydrophilic surface are used as the fine particles, it is preferred that, for example, a hydrophilic monomer is photocured to form such silica fine particles. Examples of the hydrophilic monomer include polyethyleneglycol (meth)acrylate, polyethyleneglycoldi(meth)acrylate, polyethyleneglycoltri(meth)acrylate, polypropyleneglycol(meth)acrylate, polypropyleneglycoldi(meth)acrylate, polypropyleneglycoltri(meth)acrylate, 2-hydroxyethyl (meth)acrylate, 2-hydroxypropyl (meth)acrylate, acrylamide, methylenebisacrylamide, and ethoxylated bisphenol A di(meth)acrylate. The hydrophilic monomer is not limited to any of these materials. One of these monomers may be used independently, or two or more of these monomers may be used in mixture. Needless to say, such two or more monomers may include a monofunctional monomer and a polyfunctional monomer, or may include two or more polyfunctional monomers.

These monomers may be cured when appropriate by use of a photoinitiator. Examples of the photoinitiator include carbonyl compounds such as benzoinether, benzophenone, anthraquinone, thioxane, ketal, acetophenone, and the like; sulfur compounds such as disulfide, dithiocarbamate, and the like; organic peroxides such as benzoyl peroxide, and the like; azo compounds; transfer metal complexes; polysilane compounds; dye sensitizers; and the like. Such a photoinitiator is contained at a content that is preferably not lower than 0.05 parts by mass and not higher than 3 parts by mass, and more preferably, not lower than 0.05 parts by mass and not higher than 1 part by mass, with respect to 100 parts by mass of the mixture of the fine particles and the monomer.

Where the refractive index of the matrix to the visible light is n_{M} and the refractive index of the fine particles to the visible light is n_{P}, |n_{M}−n_{P}| (hereinafter, may be referred to simply as the “refractive index difference”) is preferably not smaller than 0.01 and not larger than 0.6, and more preferably, not smaller than 0.03 and not larger than 0.11. If the refractive index difference is smaller than 0.03, the scattering intensity is too weak to easily provide desired optical characteristics. If the refractive index difference is larger than 0.11, the infrared regular transmittance may be decreased. In the case where, for example, zirconia fine particles (refractive index: 2.13) and an acrylic resin are used to realize a refractive index difference of 0.6, the thickness may be decreased to adjust the infrared regular transmittance. As can be seen, the infrared regular transmittance is adjustable by, for example, controlling the thickness of the visible light scattering layer and the refractive index difference. For a certain use, the visible light scattering layer 110A and a filter absorbing infrared rays may be used in a stacking manner. The refractive index to the visible light may be represented by, for example, the refractive index to light of 546 nm. Herein, the “refractive index” refers to a refractive index to light of 546 nm unless otherwise specified.

FIG. 7 shows a cross-sectional TEM image of the visible light scattering layer 110A. In the TEM image in the figure, white circles are silica fine particles and black circles are sites from which the silica fine particles have been dropped. As shown in the cross-sectional TEM image of the visible light scattering layer 110A, the silica fine particles are dispersed almost uniformly.

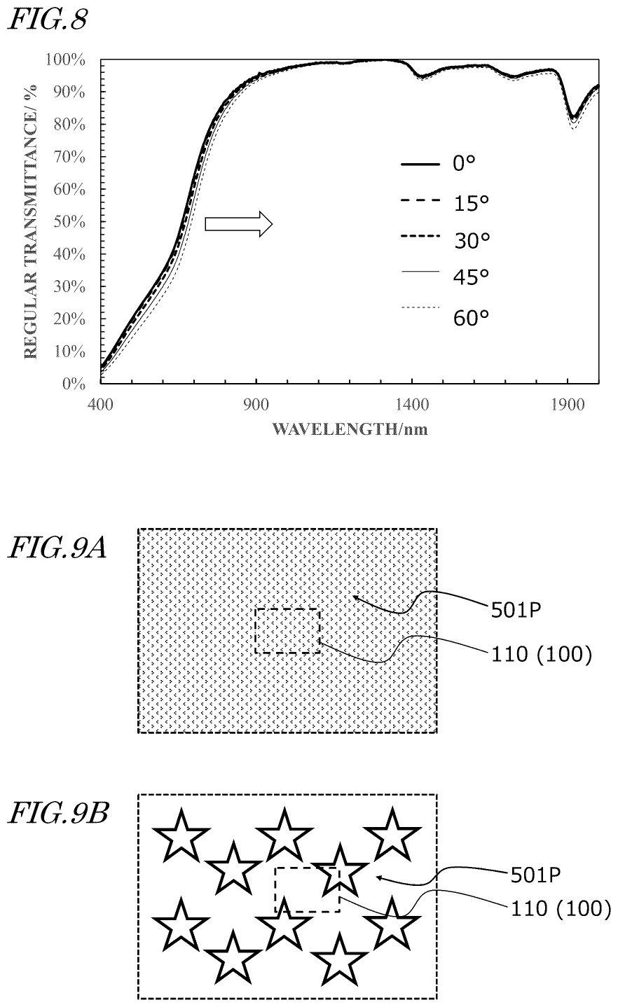

FIG. 8 is a graph showing the angle-of-incidence dependence of the regular transmittance spectrum of the visible light scattering layer 110A normalized by the maximum transmittance. Regarding the transmittance curve of the visible light scattering layer 110A shown in FIG. 8, the curved portion in which the regular transmittance monotonously increases from the visible light to the infrared rays is shifted to the longer wavelength side (by about 50 nm) as the angle of incidence is increased. In other words, the curved portion in which the regular transmittance monotonously decreases from the infrared rays to the visible light is shifted to the longer wavelength side as the angle of incidence is increased. Such characteristic angle-of-incidence dependence is considered to be caused by the silica fine particles contained in the optical film forming a colloidal amorphous array. The structure of, the optical characteristics of, and the method for producing, the visible light scattering layer 110A are described in detail in International Application PCT/JP2021/010413 filed by the present Applicant. The entirety of PCT/JP2021/010413 is incorporated herein by reference.

As shown in FIG. 5, the optical stack 110 according to an embodiment of the present invention includes the design layer 110C on the visible light scattering layer 110A. In this specification, the term “design” refers to a pattern or a color of an item. The pattern encompasses a pictorial pattern or a graphical pattern. The color may be a single color, and may encompass a combination of colors having the same hue and different chromas. The color, the pictorial pattern or the graphical pattern may be tile-like. Examples of the design will be described in more detail below. The design layer 110C preferably has a high infrared transmittance. The design layer 110C may be like a film such as a decorative film or the like, or may not be like a film. The design layer 110C has a thickness that is, for example, not less than 1 μm and not greater than 150 μm.

The optical stack 110 may further include another functional layer exhibiting a specific function. In this case, a single functional layer may exhibit two or more functions, or at least one of the above-described layers may be provided with another function. There is no specific limitation on the function that may be provided to the optical stack 110. The optical stack 110 according to an embodiment of the present invention further includes a surface protective layer 110D shown in FIG. 5 at a surface thereof. The surface protective layer 110D is configured to exhibit, for example, a hard coating (HC) function having scratch resistance, an anti-fouling function, an anti-glare (AG) function, an anti-reflection (AR) function or the like.

Herein, the color of a surface of a periphery 501P of an area where the detection unit 100 is located will be referred to as a “periphery color”, and the color of a surface of the detection unit 100 will be referred to as a “detector color”. Herein, the detector color is the color of the surface of the optical stack 110. Neither the periphery color nor the detector color is black, and the color difference between the periphery color and the detector color measured by the SCE method is not larger than 3. Specifically, the conditions of the numerical formulas in expression 1 are satisfied as described above. An example of L*a*b* color coordinate system is the CIE 1976 L*a*b* color coordinate system. From the point of view of improving the harmony of the periphery color and the detector color, the color difference is preferably not larger than 1.5, and more preferably, not larger than 0.4.

As long as the color difference is not larger than 3, a superb design is provided by harmonizing the periphery color and the detector color such that these colors are not distinguishable from each other. In this state, the infrared detection device 120 and the light emitting device 130 are allowed to be hidden by the optical stack 110 so as not to be visually recognizable from outside. For example, a situation is effectively suppressed where knowledge of the presence of the infrared detection device 120 and the light emitting device 130 causes people to, as a result of a psychological change, make an act or motion that they would not make without such knowledge.

As shown in FIG. 4 as an example, where the design of the surface of the periphery 501P of the area where the detection unit 100 is located is referred to as a “periphery design” and the design of the surface of the optical stack 110 is referred to as a “detector design”, the detector design is the same as, or similar to, the periphery design. The detector design and the periphery design may have the same pattern or the same color. For example, a decorative film may be used to provide the surface of the optical stack 110 and the surface of the periphery 501P with a design of a pattern or a color. The surface protective layer described above may be provided on the surface of the periphery 501P.

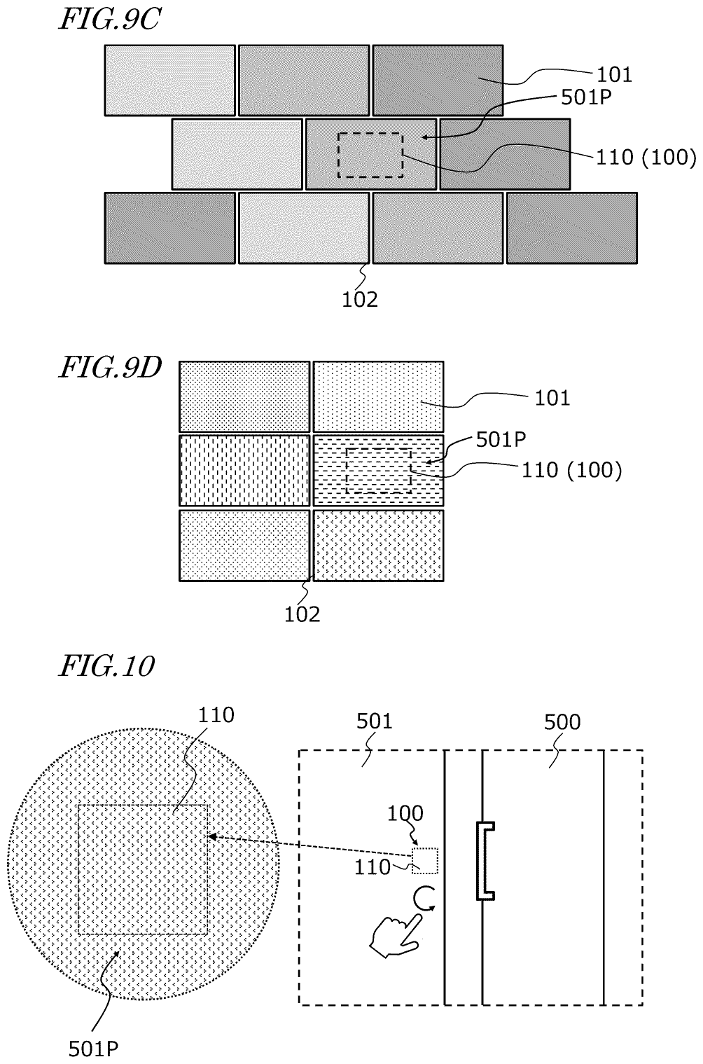

With reference to FIG. 9A through FIG. 9D, examples of design that may be provided to the surface of the optical stack 110 and the surface of the periphery 501P of the area where the detection unit 100 is located will be described. FIG. 9A shows an example in which a design of a continuous pattern is provided to the surface of the optical stack 110 and the surface of the periphery 501P. In this example, a single pattern (design) is provided to the surface of the periphery 501P and the surface of the optical stack 110. This design may be realized by use of one decorative film. Therefore, there is no physical border in the film. The optical stack 110 is located at an arbitrary position in the single pattern, and each of one or a plurality of detection units 100 is hidden on the rear side of the optical stack 110.

FIG. 9B shows an example in which a design of a tile-like pattern is provided to the surface of the optical stack 110 and to the surface of the periphery 501P. The design in this example is a tile-like pattern including a graphical pattern. This design may be realized by locating a plurality of decorative films side by side on a flat surface or a curved surface including the surface of the optical stack 110 and the surface of the periphery 501P. Therefore, physical borders are present at joints between the films. A “tile-like design” encompasses a pattern in which one same-shaped motif is arranged regularly as shown in FIG. 9B, and also encompasses a pattern in which motifs of different shapes are arranged irregularly with the borders having different widths. The optical stack 110 may be located at such a border or may be located to bridge the border. Each of one or a plurality of detection units 100 is hidden on the rear side of the optical stack 110. In the example shown in FIG. 9B, the optical stack 110 is located so as to bridge the borders in the pattern including the star-shaped motifs arranged regularly.

FIG. 9C shows another example in which a design of a tile-like pattern is provided to the surface of the optical stack 110 and the surface of the periphery 501P. The design in this example is of a tile-like color including a combination of colors having the same hue and different chromas. This design may be realized by locating a plurality of decorative films side by side on a flat surface or a curved surface including the surface of the optical stack 110 and the surface of the periphery 501P. Therefore, physical borders are present at joints between the films. This design includes a plurality of zones 101 separated from each other by visually recognizable borders 102. The optical stack 110 is located in one of the plurality of zones 101. The detection unit 100 is hidden on the rear side of the optical stack 110. In the case where there are a plurality of detection units 100, the plurality of optical stacks 110 are respectively located in different zones among the plurality of zones 101. The plurality of zones 101 may each have an arbitrary color or pattern.

FIG. 9D shows still another example in which a design of a tile-like pattern is provided to the surface of the optical stack 110 and the surface of the periphery 501P. This design includes a plurality of zones 101 separated from each other by visually recognizable borders 102. The plurality of zones 101 each have an arbitrary pattern. The optical stack 110 is located in one of the plurality of zones 101. The detection unit 100 is hidden on the rear side of the optical stack 110.

### Embodiment 1

An infrared security system according to this embodiment may function in a wide range of uses as, for example, a motion tracking system or an authentication system using infrared rays for iris authentication, face authentication, vein authentication or the like. In the following description, the infrared security system functions as a motion tracking system. The motion tracking system may, for example, recognize a hand gesture, analyze human mobility, or measure the traffic volume or the speed of running vehicles. The infrared security system may also automatically sense entrance of an intruder and track or record the intruder.

A subject is irradiated with infrared rays emitted from the light emitting device 130 and transmitted through the optical stack 130. A part of the light reflected by the subject is transmitted through the optical stack 130 and is incident on the infrared sensor 122 of the infrared detection device 120. The security system 200 is configured to operate based on an output from the infrared detection device 120.

The security system 200 according to this embodiment is configured as follows. The infrared detection device 120 receives, through the optical stack 110, infrared rays emitted from the light emitting device 130 toward at least one subject and reflected by the at least one subject, and generates a subject signal. Based on the subject signal, the security system 200 generates time series data representing the motion of the at least one subject, and analyzes the motion of the at least one subject based on the time series data.

FIG. 10 shows an example in which locking of a conference room is managed by a hand gesture.

Only a person who knows, in advance, at which position in the wall 501 the detection unit 100 is installed can approach the position and make a motion of a hand gesture toward the detection unit 100. When the track of the motion of the hand gesture matches a predetermined pattern, the lock is released. By contrast, a person who does not know at which position in the wall 501 the detection unit 100 is installed cannot make the motion of the hand gesture in front of the door 500, and therefore, cannot release the lock. According to this example, the release of the lock is managed by the hand gesture, and therefore, an identification (ID) card or a key, which is conventionally necessary, is not necessary. This streamlines the security system. Even if somebody gets to know the pattern of the hand gesture, he/she cannot specify the position at which the detection unit 100 is installed. Therefore, it is difficult for him/her to release the lock. As can be seen, the infrared detection device 120 may be located so as not to be visually recognizable, so that the level of security is improved.

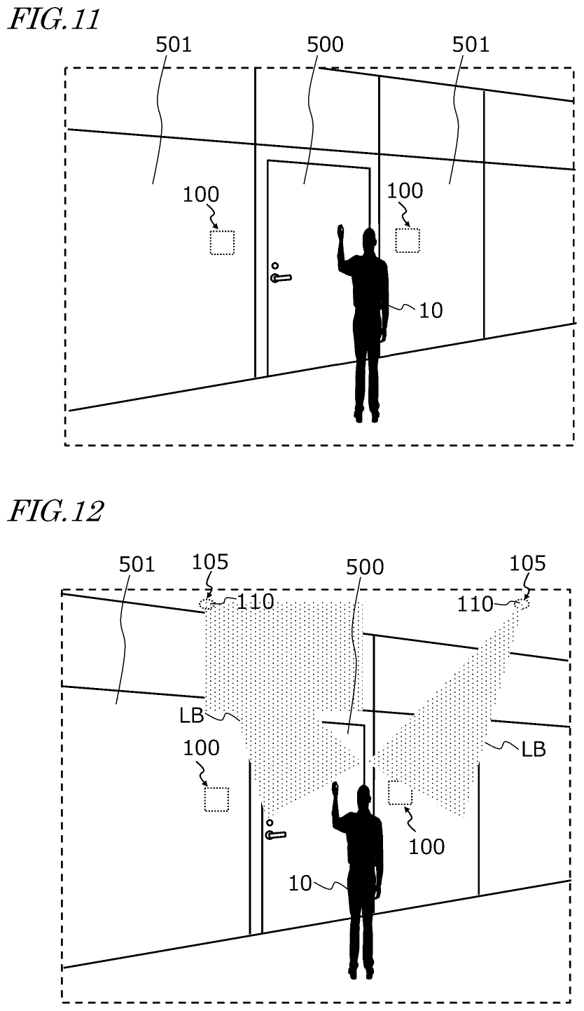

FIG. 11 schematically shows a plurality of detection units 100 installed inside the wall 501. The infrared security system 300 according to this embodiment may include the plurality of detection units 100. In the example shown here, two detection units 100 are located on both of two sides of the door 500. The provision of the two detection units 100, for example, allows a motion of a subject 10 to be tracked while the subject 10 is moving. In the case where an image is captured with one camera, a problem of so-called “occlusion” occurs where the motion of the subject 10 cannot be detected when, for example, the subject 10 is hidden behind another person. The provision of the two detection units 100 solves such a problem.

According to this embodiment, a design unit 400 (see FIG. 4) including one or a plurality of detection units 100 and the wall 501 accommodating the one or the plurality of detection units 100 is provided. The infrared security system 300 includes the design unit and the security system 200 operative based on an output from the infrared detection device 120. Herein, the wall 501 may be referred to as an “accommodation portion”. An outer surface of the accommodation portion includes the surface of the optical stack 110 included in each of the one or the plurality of detection units 100. The outer surface of the accommodation portion and the surface of the optical stack 110 may be provided with the same or similar patterns or colors.

The infrared detection device 120 is located on the side opposite to the surface of the optical stack 110 such that the position of the infrared detection device 120 is not specified. Where the color of the outer surface is referred to as a “periphery color” and the color of the surface of the optical stack 110 is referred to as a “detector color”, neither the periphery color nor the detector color is black, and the color difference between the periphery color and the detector color measured by the SCE method is not larger than 3. As can be seen, a design unit having a superb design may be provided by harmonizing the periphery color and the color of the surface of the optical stack 110 such that these colors are not distinguishable from each other.

As described above with reference to FIG. 9A or FIG. 9B, the outer surface of the accommodation portion and the surface of the optical stack 110 may be provided with a design of a continuous pattern. The optical stack 110 is located at an arbitrary position in the continuous pattern. As described above with reference to FIG. 9C or FIG. 9D, the outer surface of the accommodation portion and the surface of the optical stack 110 may be provided with a tile-like design including a plurality of zones separated from each other by visually recognizable borders. The one or the plurality of optical stacks 110 are located in different zones among the plurality of zones. The plurality of zones 101 may each have an arbitrary color or pattern.

FIG. 12 shows an example in which the detection units 100 are installed inside the wall 501 and one or more light source units 105 are located in a ceiling so as not to be seen from outside.

The one or more light source units 105 each include the optical stack 110 and the light emitting device 130. An operation of each light source unit 110 is controlled by a light emission control system. The light emission control system has a hardware configuration same as the hardware configuration shown in FIG. 3. In the example shown in FIG. 12, the light emitting devices 130 are installed at different positions from those of the infrared detection devices 120. Where the color of the surface of the periphery of the area where each of the light source units 105 is located is referred to as a “periphery color” and the color of the surface of each of the light source units 105 is referred to as a “detector color”, neither the periphery color nor the detector color is black, and the color difference between the periphery color and the detector color measured by the SCE method is not larger than 3. With such a positional arrangement, the subject 10 is irradiated with infrared rays LB emitted from the light source units 105 installed in the ceiling, and the detection units 110 receive the light reflected by the subject 10.

The detection unit(s) 100 and/or the light source unit(s) 105 according to this embodiment is not limited to being installed indoors, for example, in stores, facilities, airports, train stations or the like, and may also be installed outdoors, for example, on roads, crossroads, parking lots or the like. For example, a plurality of detection units 100 and/or light source units 105 may be located on a pathway connecting an entrance of an exhibition hall and a room in the exhibition hall, so that the human mobility is analyzed. In addition, the streamlining of the security system provides an effect of decreasing the number of staff members such as the receptionists or the security guards patrolling the exhibition hall. For example, the human mobility analysis algorithm described in Japanese Laid-Open Patent Publication No. 2017-224148 is preferably usable. The entirety of Japanese Laid-Open Patent Publication No. 2017-224148 is incorporated herein by reference. For example, a plurality of detection units 100 and/or light source units 105 may be located in a plurality of sign posts installed on expressways with intervals, so that the traffic volume or the speed of the running vehicles is measured.

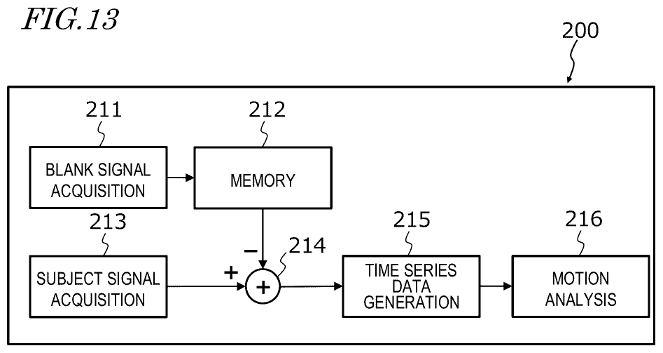

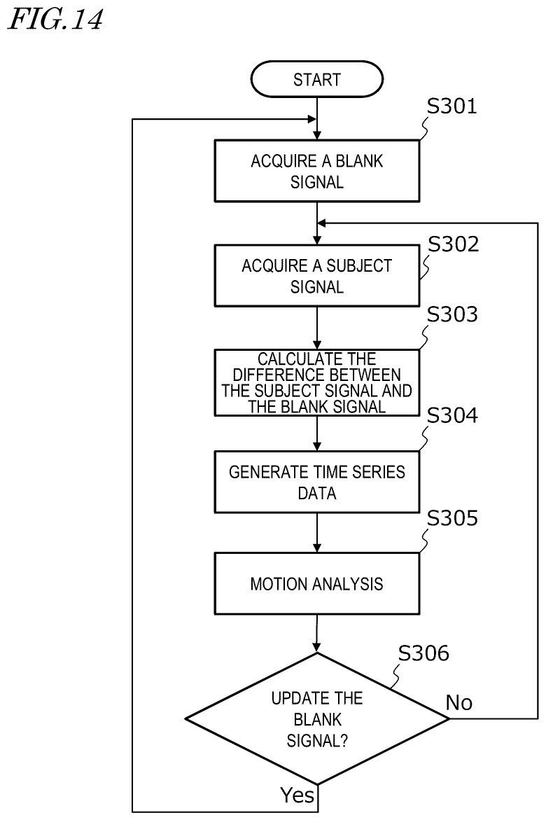

FIG. 13 is a block diagram showing, with functional blocks, an example of process executed by the processor 210 in the case where the security system 200 tracks a motion of a moving body. FIG. 14 is a flowchart showing an example of procedure of tracking the motion of the moving body.

The processor 210 executes processes of blank signal acquisition 211, subject signal acquisition 213, difference computation 214, time series data generation 215, and motion analysis 216. The process (or task) of each of the functional blocks is typically described in a computer program in units of software module.

### (Step S301)

The processor 210 of the security system 200 operates referring to a blank signal generated by the infrared detection device 120 when the infrared detection device 120 receives reference infrared rays through the optical stack 110. The blank signal does not include information on the subject. In response to a control signal that is output from the security system 200 when the subject is not present in the angle of view of the infrared detection device 120 (or the infrared sensor 122), the light emitting device 130 emits infrared rays. The infrared rays emitted at this point are referred to as “reference infrared rays”. The infrared detection device 120 outputs a blank signal of a level corresponding to the intensity of the reference infrared rays transmitted through the optical stack 110.

As shown in FIG. 9A through FIG. 9D as examples, the periphery design and the detector design according to this embodiment each include a pattern. In this case, a blank signal of a level corresponding to the intensity of the reference infrared rays transmitted through the optical stack 110 having the pattern at the surface thereof is output from the infrared detection device 120. The blank signal represents an intensity specific to the pattern. A memory 212 (e.g., the ROM 220) stores the blank signal specific to the pattern. For example, the reference infrared rays may be emitted from the light emitting device 130 at the time of calibration of the detection unit 100. Alternatively, the reference infrared rays may be emitted from the light emitting device 130 every certain period of time, namely, on a regular basis. In this case, the processor 210 acquires the blank signal every certain period of time and stores the acquired blank signal on the memory 212. In this manner, the blank signal stored on the memory 212 may be updated every certain period of time.

### (Step S302)

The infrared detection device 120 outputs a subject signal of a level corresponding to the intensity of the infrared rays reflected by the subject 10 and transmitted through the optical stack 110. The subject signal includes information on the subject 10.

### (Step S303)

The processor 210 operates based on a difference between the subject signal, generated by the infrared detection device 120 when the infrared detection device 120 receives, through the optical stack 110, the infrared rays emitted from the light emitting device 130 toward at least one subject 10 and reflected by the at least one subject 10, and the blank signal. A subtraction device may perform a computation of reading the blank signal from the memory 212 and subtracting the blank signal from the subject signal, for example, frame by frame.

### (Steps S304 and S305)

Based on the difference between the subject signal and the blank signal, the processor 210 generates time series data representing the motion of the at least one subject 10 (e.g., motion by the hand gesture) and analyzes the motion of the at least one subject 10 based on the time series data. Based on the difference, output from the subtraction device, between the subject signal and the blank signal, the processor 210 generates the time series data representing the motion of the subject 10. The time series data includes information on the motion of the subject between a plurality of frames. The processor 210 may, for example, detect a motion vector of the subject by use of the time series data, and analyze the motion of the subject 10 based on the motion vector. Alternatively, the processor 210 may apply the motion capture algorithm described in, for example, Japanese Patent No. 4148281 to analyze the motion of the subject 10. The entirety of Japanese Patent No. 4148281 is incorporated herein by reference.

### (Step S306)

In the case where it is necessary to update the blank signal, the processor 210 acquires the blank signal on a regular basis for updating (Yes in step S306). In the case where it is not necessary to update the blank signal, the processor 210 acquires the subject signal (No in step S306).

According to the signal processing in this embodiment, even in the case where the surface of the optical stack 110 is provided with a pattern, the difference between the subject signal and the blank signal specific to the pattern may be calculated, so that an offset component caused by the infrared rays transmitted through the pattern is removed from the subject signal. Therefore, the precision of the motion analysis on the subject 10 may be improved.

The security system 200 is not limited to tracking a motion, and may be configured to perform iris authentication, face authentication, vein authentication or the like. For example, the algorithm for iris authentication described in Japanese Laid-Open Patent Publication No. 2020-160757, the algorithm for face authentication described in Japanese Laid-Open Patent Publication No. 2020-129175, and the algorithm for vein authentication described in Japanese Laid-Open Patent Publication No. 2019-159869 are preferably usable. The entirety of these patent publications is incorporated herein by reference.

### Embodiment 2

An infrared security system according to this embodiment is a system that manages release of lock. The infrared security system includes at least one detection unit including an optical stack and an infrared detection device located so as to receive infrared rays through the optical stack, and a security system operative based on an output from the infrared detection device. The security system is configured as follows. The infrared detection device receives, through the optical stack, infrared rays emitted from the light emitting device toward a subject and reflected by the subject, and generates a subject signal. Based on the subject signal, the security system generates time series data representing the motion of the subject, and releases the lock based on the time series data.

Conventionally, there is a problem that recognition of the location of the unlocking system by a third party increases the risk of the lock being released. According to this embodiment, any two selected from, for example, detection of the position of the subject, detection of the motion of the subject and an unlocking code input by the subject may be combined, so that two-factor authentication is realized. For example, a combination of the detection of the position of the subject and the detection of the motion of the subject may provide a contactless unlocking system that is not visually recognizable from outside.

FIG. 15 is a block diagram showing, with functional blocks, an example of process executed by the processor 210 of a security system 200A in example 1.

The processor 210 included in the security system 200A in this example executes processes of the blank signal acquisition 211, the subject signal acquisition 213, the difference computation 214, the time series data generation 215 and the motion analysis 216, and also processes of subject position detection 217 and lock release determination 218.

Based on the subject signal that is output from the infrared detection device 120, the processor 210 calculates a positional relationship of the subject to the infrared detection device 120. For example, the processor 210 may use an external parameter of the infrared detection device (camera) 120 to convert a world coordinate system into a camera coordinate system. The processor 210 may perform such coordinate conversion to calculate the positional relationship of the subject to the infrared detection device 120. For example, the method for detecting a relative position of a person described in Japanese Laid-Open Patent Publication No. 2017-224148 is preferably usable.

The processor 210 releases the lock based on the time series data and the positional relationship. For example, in the case where the motion of the subject matches a designated motion pattern and the subject in the camera coordinate system is located in a predetermined range for a certain period of time, the processor 210 releases the lock. An example of the motion of the subject is a hand gesture. The certain period of time may be set to, for example, a time period that is not shorter than 3 seconds and not longer than 10 seconds.

According to this example, a combination of the detection of the position of the subject and the detection of the motion of the subject may provide a contactless unlocking system that is not visually recognizable from outside. Only a person who is permitted, in advance, to release the lock can get to know the position of the hidden detection unit. A physical key or a card key is made unnecessary. Unless a person makes a designated act at a designated position, the lock cannot be released.

For example, the detection of the position of the subject may be combined with iris authentication, face authentication or vein authentication, instead of the detection of the motion of the subject, so that two-factor authentication is realized. Thus, the level of security may be improved.

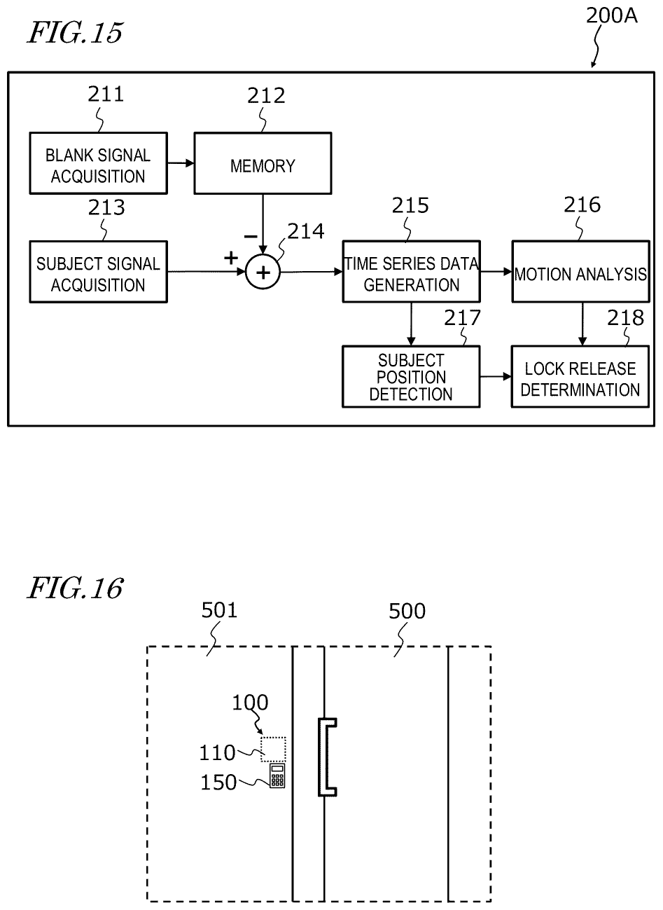

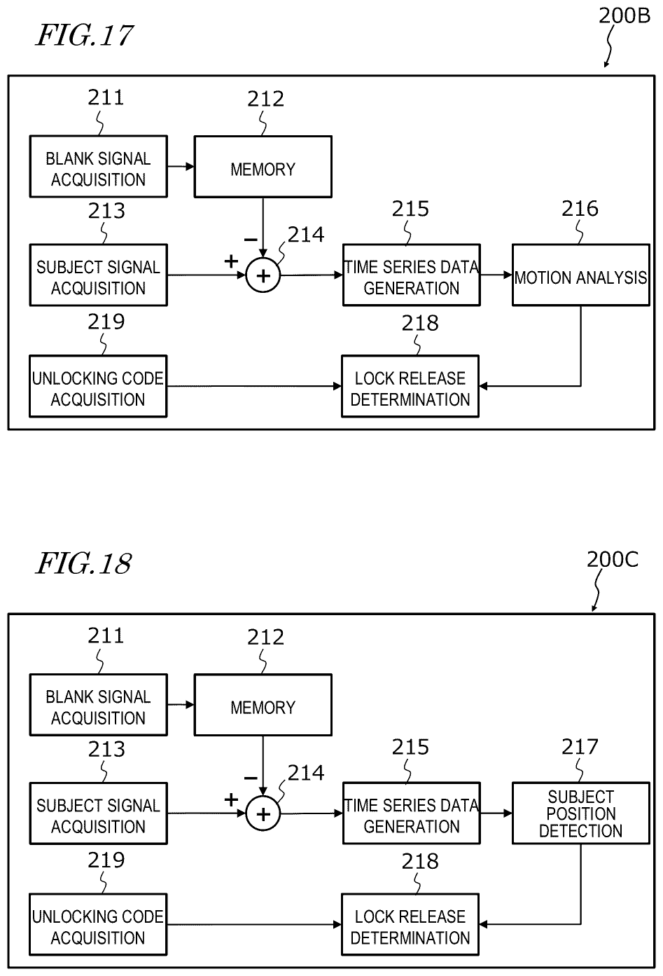

FIG. 16 schematically shows the detection unit 100 installed inside the wall 501 and an input device 150 provided on the wall 501. FIG. 17 is a block diagram showing, with functional blocks, an example of process executed by the processor 210 of a security system 200B in example 2.

The input device 150 converts an unlocking code input by the subject into data, and inputs the data to the security system 200B. The input device 150 may include a display portion that displays buttons usable to input the unlocking code and the input numbers. The input device 150 may function, for example, as a card reader that reads the unlocking code from the card key or as a device that reads a two-dimensional code displayed on a terminal device such as a smartphone or the like.

The processor 210 included in the security system 200B in this example executes processes of the blank signal acquisition 211, the subject signal acquisition 213, the difference computation 214, the time series data generation 215 and the motion analysis 216, and also processes of unlocking code acquisition 219 and the lock release determination 218.

The processor 210 acquires information on the unlocking code that is output from the input device 150. In the case where the motion of the subject matches a designated motion pattern and the unlocking code matches a designated code, the processor 210 releases the lock. Mere input of the unlocking code conventionally performed has a risk of the lock being released. The motion of the subject and the unlocking code may be combined in this manner, so that two-factor authentication is realized. Thus, the level of security may be improved.

FIG. 18 is a block diagram showing, with functional blocks, an example of process executed by the processor 210 of a security system 200C in example 3. The processor 210 included in the security system 200C in this example executes processes of the blank signal acquisition 211, the subject signal acquisition 213, the difference computation 214, the time series data generation 215 and the subject position detection 217, and also processes of the unlocking code acquisition 219 and the lock release determination 218.

The processor 210 acquires information on the unlocking code that is output from the input device 150. In the case where the subject in the camera coordinate system is located in a predetermined range for a certain period of time and the unlocking code matches a designated code, the processor 210 releases the lock. Mere input of the unlocking code conventionally performed has a risk of the lock being released. The detection of the motion of the subject and the unlocking code may be combined in this manner, so that two-factor authentication is realized. Thus, the level of security may be improved.

A combination of the detection of the position of the subject, the detection of the motion of the subject and the unlocking code realizes multi-factor authentication. Thus, the level of security may be further improved. In addition, another factor such as iris authentication, face authentication, vein authentication or the like may be added, so that the level of security is still further improved.

An infrared security system according to an embodiment of the present invention is usable for, for example, authentication technologies, tracking technologies and the like using infrared rays.

1. An infrared security system managing release of lock, comprising:
at least one detection unit including an optical stack and an infrared detection device located so as to receive infrared rays through the optical stack; and
a security system operative based on an output from the infrared detection device,
wherein the security system is configured to:
generate time series data representing a motion of a subject based on a subject signal generated by the infrared detection device when the infrared detection device receives, through the optical stack, infrared rays emitted from a light emitting device toward the subject and reflected by the subject, and
release the lock based on the time series data.

2. The infrared security system of claim 1, wherein the security system:
calculates a positional relationship of the subject to the infrared detection device based on the subject signal from the infrared detection device, and
releases the lock based on the time series data and the positional relationship.

3. The infrared security system of claim 1, further comprising an input device converting an unlocking code, input by the subject, into data and inputting the data to the security system,
wherein the security system releases the lock in the case where the motion of the subject matches a designated motion pattern and the input unlocking code matches a designated code.

4. An infrared security system managing release of lock, comprising:
at least one detection unit including an optical stack and an infrared detection device located so as to receive infrared rays through the optical stack;
a security system operative based on an output from the infrared detection device; and
an input device converting an unlocking code, input by a subject, into data and inputting the data to the security system,
wherein the security system is configured to:
calculate a positional relationship of the subject to the infrared detection device based on a subject signal generated by the infrared detection device when the infrared detection device receives, through the optical stack, infrared rays emitted from a light emitting device toward the subject and reflected by the subject, and
release the lock based on the calculated positional relationship and the input unlocking code.

5. The infrared security system of claim 1,
wherein where a design of a surface of a periphery of an area where the at least one detection unit is located is referred to as a periphery design and a design of a surface of the optical stack is referred to as a detector design, the detector design is similar to the periphery design, and
wherein the security system operates referring to a blank signal not including information on a subject, the blank signal being generated by the infrared detection device when the infrared detection device receives reference infrared rays through the optical stack.

6. The infrared security system of claim 5, wherein the security system acquires the blank signal every certain period of time.

7. The infrared security system of claim 5,
wherein the periphery design and the detector design each include a pattern, and
wherein the infrared security system further includes a storage device storing the blank signal specific to the pattern.

8. The infrared security system of claim 5, wherein the security system generates time series data based on a difference between the subject signal and the blank signal.

9. The infrared security system of claim 1,
wherein a value of L* at a surface of the optical stack measured by an SCE method is not smaller than 4, and
wherein the infrared detection device is located on a side opposite to the surface of the optical stack such that a position of the infrared detection device is not specified.

10. The infrared security system of claim 9, wherein where a color of a surface of a periphery of an area where the at least one detection unit is located is referred to as a periphery color and a color of a surface of the at least one detection unit is referred to as a detector color, neither the periphery color nor the detector color is black, and a color difference between the periphery color and the detector color measured by the SCE method is not larger than 3.

11. The infrared security system of claim 1, wherein the at least one detection unit includes the light emitting device emitting infrared rays outside through the optical stack.

12. The infrared security system of claim 1, wherein the at least one detection unit includes a plurality of detection units.

13. An infrared security system managing release of lock, comprising:
at least one detection unit including an optical stack and an infrared detection device located so as to receive infrared rays through the optical stack; and
a security system configured to release the lock based on an output from the infrared detection device,
wherein where a design of a surface of a periphery of an area where the at least one detection unit is located is referred to as a periphery design and a design of a surface of the optical stack is referred to as a detector design, the detector design and the periphery design are the same as, or similar to, each other, and
wherein the security system operates referring to a blank signal not including information on a subject, the blank signal being generated by the infrared detection device when the infrared detection device receives reference infrared rays through the optical stack.

14. The infrared security system of claim 13,
wherein the entirety of the detection design and the periphery design includes a single pattern, and
wherein the optical stack included in each of the one or the plurality of detection units is located at an arbitrary position in the single pattern, and the one or the plurality of detection units are each hidden on a rear side of the optical stack.

15. The infrared security system of claim 13,
wherein the detector design and the periphery design include a plurality of zones separated from each other by a visually recognizable border,
wherein the optical stack included in each of the one or the plurality of detection units is located in a different zone among the plurality of zones, and the one or the plurality of detection units are each hidden on a rear side of the optical stack, and
wherein the plurality of zones each have an arbitrary color or pattern.

16. The infrared security system of claim 1, wherein the optical stack includes a visible light scattering layer containing fine particles acting as light scattering elements dispersed in a matrix, the visible light scattering layer having a regular transmittance not lower than 60% for light having a wavelength in at least a part of the wavelength range not shorter than 760 nm and not longer than 2000 nm.

17. The infrared security system of claim 16, wherein the fine particles form at least a colloidal amorphous array.

18. The infrared security system of claim 16, wherein a transmittance curve of the visible light scattering layer for light in a wavelength range of visible light includes a curved portion in which the regular transmittance monotonously decreases from a longer wavelength side to a shorter wavelength side, and the curved portion is shifted to the longer wavelength side as an angle of incidence is increased.
